(19) United States
(12) Patent Application Publication
(10) Pub. No.: US 2024/0336401 A1
(43) Pub. Date: Oct. 10, 2024

(54) Bucket and Liner Device

(71) Applicant: William Hope Watts, Columbia, TN (US)

(72) Inventor: William Hope Watts, Columbia, TN (US)

(21) Appl. No.: 18/504,550

(22) Filed: Nov. 8, 2023

Related U.S. Application Data
(60) Provisional application No. 63/494,569, filed on Apr. 6, 2023.

(51) Int. Cl. B65D 25/16; B05B 9/03; B65D 25/24; B65D 25/28; B65D 25/38

(52) U.S. Cl. CPC B65D 25/16; B05B 9/03; B65D 25/24; B65D 25/2879; B65D 25/38

(57) ABSTRACT

An airless spray bucket and liner device for spray paint and stain applications. The device provides easy and convenient paint spraying operation and efficient clean-up of the bucket after paint spraying. The device includes a five-gallon bucket with a clean-out mechanism in the form of a hole and cap for color changes and easy cleaning. An extension and supporting legs provide stability during use, thereby preventing spills. A liner designed to conform to the inner walls and base of the bucket is removably positioned inside the bucket and the liner functions as a protective barrier between the paint stored inside the bucket and the walls of the bucket. An airless spray gun can be attached to the hole for spraying paint and a vacuum device can be detachably attached or integrated to the hole for cleaning out residual paint.

### CROSS-REFERENCE TO RELATED APPLICATION

The present application claims priority to, and the benefit of, U.S. Provisional Application No. 63/494,569, which was filed on Apr. 6, 2023, and is incorporated herein by reference in its entirety.

### FIELD OF THE INVENTION

The present invention generally relates to the field of paint spray buckets. More specifically, the present invention relates to a novel device and solution for spray paint and stain applications, offering easy operation and efficient cleanup. The solution includes a bucket and a liner. The liner is placed inside the bucket and functions as a protective barrier between the paint stored in the bucket and walls of the bucket. This allows easy cleaning and use of less paint thinner for removing paint from bucket. A hole is positioned at the base of the bucket allowing a user to use airless spray gun and a vacuum device. Accordingly, the present disclosure makes specific reference thereto. Nonetheless, it is to be appreciated that aspects of the present invention are also equally applicable to other like applications, devices, and methods of manufacture.

### BACKGROUND

By way of background, a bucket or container is used for feeding the sprayer for spraying paint. The paint is first prepared and stored in the bucket and then the sprayer is operated to spray the paint. In cases, when the paint is thick or has been stored in the bucket for a considerable time, paint thinner or other additives may be required for smooth flow of the paint through the sprayer nozzle. The sprayer commonly uses a combination of compressed air and the paint's own pressure to atomize the paint into fine particles. Further, cleaning up of the bucket is performed after completion of the painting task. However, cleaning up after using a paint bucket can be frustrating and time consuming as paint can be difficult to remove, especially when the paint has dried. When a paint bucket is not cleaned thoroughly, the remnants of one color may mix with other colors of paint, leading to unintended color variations which can ruin the finish of the paint job.

Traditionally, cleaning a paint bucket is performed by scraping off as much paint as possible from the bucket's interior walls which can be messy, laborious, and time-consuming. Often, the bucket is soaked in soapy water for several hours or overnight which can delay the process of spraying paint. The traditional cleanup processes for paint sprayers and associated equipment take a significant amount of time, are tiring and repetitive, and inefficient. The process often requires water and cleaning agents for soaking and scrubbing, contributing to resource consumption. Individuals desire a streamlined and efficient system for paint application and cleanup to make cleanup easier and less time-consuming. Conventional paint buckets are not stable while spraying paint and may tilt or fall resulting in a mess. Further, the paint flow may be uneven and there can be clogs and disruptions. Individuals desire an improved paint bucket that remains stable during paint spraying and provides an optimized paint flow.

Therefore, there exists a long felt need in the art for a spray paint device that prevents color mixing in a paint bucket. Additionally, there is a long felt need in the art for an improved spray paint bucket device system that simplifies cleanup of a paint bucket and reduces the need for extensive scraping and scrubbing by using a liner. Moreover, there is a long felt need in the art for an improved spray paint device that provides a contained and organized system for holding the paint, improving the overall paint application process. Further, there is a long felt need in the art for an improved paint bucket device that provides more stability and reduces the risk of spills or accidents. Furthermore, there is a long felt need in the art for an improved paint spray system that provides an optimal and consistent flow of paint. Finally, there is a long felt need in the art for an airless spray bucket and liner system that saves extensive time and effort when cleaning up bucket and other equipment after painting.

The subject matter disclosed and claimed herein, in one embodiment thereof, comprises an airless spray bucket and liner device that work in conjunction to offer easy and convenient cleaning of the bucket after spraying paint. The device features a bucket having a frame, the frame having an open rim and a base, the base having a clean-out exit situated at the center thereof, the clean-out exit is adaptable to an air spray gun for spraying paint and a vacuum device for cleaning out residual paint after spray painting. An extension is positioned below the base and is integrally connected to four supporting legs that extend beyond the base enabling secure placement of the bucket on various surfaces without tipping or wobbling. The device includes a liner device that conforms to the interior shape of the bucket, the liner device serves as a protective barrier between the paint or stain and the bucket, wherein the liner device is inserted into the bucket, allowing the paint or stain to be stored therein without the paint touching the inner walls of the bucket.

In this manner, the airless spray bucket and liner device of the present invention accomplishes all of the forgoing objectives and provides users with a liner that can be removably placed inside a spray bucket to offer easy and convenient cleaning of the bucket after spraying paint. The device provides a stable bucket for painting and a spray gun and a vacuum device can be easily used for easy flowing and convenient cleaning of the paint. The devices saves extensive time and effort when cleaning up after painting.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an airless spray bucket and liner device. The device is designed as a spray paint device for facilitating spray painting operations while ensuring convenient and efficient cleaning of the bucket after paint application. The device further comprising a bucket having a frame, the frame having an open rim and a base, the base having a clean-out exit situated at the center thereof, the clean-out exit is adaptable to an air spray gun and a vacuum device, an extension positioned below the base and integrally connected to four supporting legs that extend beyond the base for enabling secure placement of the bucket on various surfaces without tipping or wobbling. The device includes a liner device that conforms to the interior shape of the bucket, the liner device serves as a protective barrier between paint or stain and the bucket walls, wherein the liner device is inserted into the bucket, allowing the paint or stain to be stored therein.

In yet another embodiment, a spray paint or stain device is disclosed. The device includes a five-gallon bucket with a bottom clean out hole to prevent the mixing of colors. A liner conforming to shape of the bucket is positioned inside the bucket to act as a protective barrier between the paint stored in the bucket and the walls of the bucket. The bucket has an extension located at the base of the bucket, and four supporting legs longer than the base of the bucket to further improve stabilization when painting. An airless spray is connected to the bottom clean out hole for spraying paint and after spraying, a vacuum device is attached to the bottom clean out hole for removing any unused paint.

In a further embodiment, a method for utilizing an airless spray bucket and liner device in a spray paint application process is described. The method comprising the steps of providing the device, the device includes a bucket with a frame, an open rim, a bottom surface having a clean-out exit, an extension with supporting legs, and a liner device. Placing the liner device inside the bucket and the liner is conforming to the inner surface of the bucket to protect against direct contact between paint or stain and the bucket, and subsequently filling the bucket with paint or stain, connecting an airless spray device to the clean-out exit at the base of the bucket for the purpose of atomizing paint into a fine spray, after the completion of the spray painting process, connecting a vacuum and clean-out device to the clean-out exit to remove excess paint from the base of the bucket and removing the liner device from the bucket.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an airless spray bucket and liner device of the present invention in accordance with the disclosed architecture;

FIG. 2 illustrates a perspective view of a multi-gallon bucket of the airless spray bucket and liner device of the present invention in accordance with the disclosed architecture;

FIG. 3 illustrates a perspective view of showing an exemplary liner positioned inside the bucket for fitting along the interior shape of the bucket in accordance with the disclosed architecture;

FIG. 4 illustrates a flow chart depicting a process of using the spray bucket and liner device of the present invention for spraying paint and cleaning the bucket in accordance with the disclosed architecture; and

FIG. 5 illustrates a top view of the bucket of the spray bucket and liner system of the present invention in accordance with another embodiment of the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a spray paint device that prevents color mixing in a paint bucket. Additionally, there is a long felt need in the art for an improved spray paint bucket device system that simplifies cleanup of a paint bucket and reduces the need for extensive scraping and scrubbing by using a liner. Moreover, there is a long felt need in the art for an improved spray paint device that provides a contained and organized system for holding the paint, improving the overall paint application process. Further, there is a long felt need in the art for an improved paint bucket device that provides more stability and reduces the risk of spills or accidents. Furthermore, there is a long felt need in the art for an improved paint spray system that provides an optimal and consistent flow of paint. Finally, there is a long felt need in the art for an airless spray bucket and liner system that saves extensive time and effort when cleaning the bucket and other equipment after painting.

The present invention, in one exemplary embodiment, is a method for utilizing an airless spray bucket and liner device in a spray paint application process. The method includes the steps of providing the device, the device includes a bucket with a frame, an open rim, a bottom surface having a clean-out exit, an extension with supporting legs, and a liner device. Placing the liner device inside the bucket wherein the liner is conforming to the inner surface of the bucket to protect against direct contact between paint or stain and the bucket, and subsequently filling the bucket with paint or stain, connecting an airless spray device to the clean-out exit at the base of the bucket for the purpose of atomizing paint into a fine spray, after the completion of the spray painting process, connecting a vacuum and clean-out device to the clean-out exit to remove excess paint from the base of the bucket and removing the liner device from the bucket.

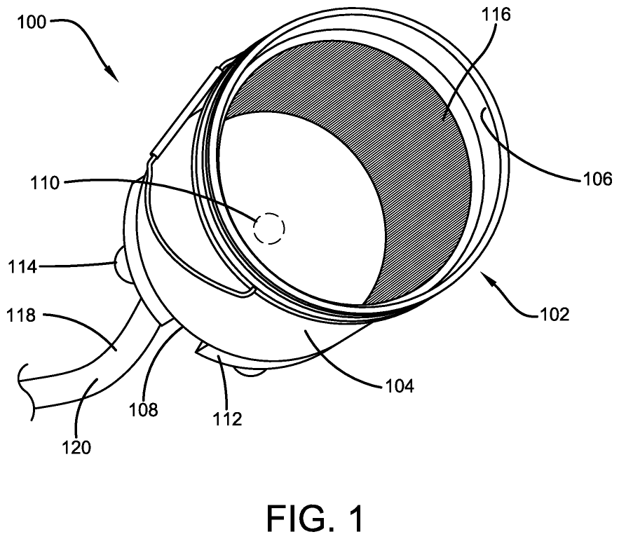

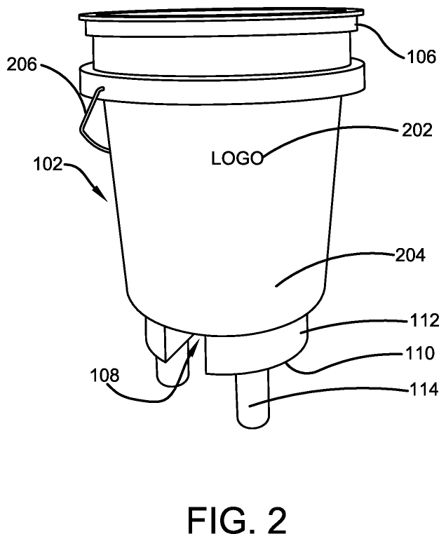

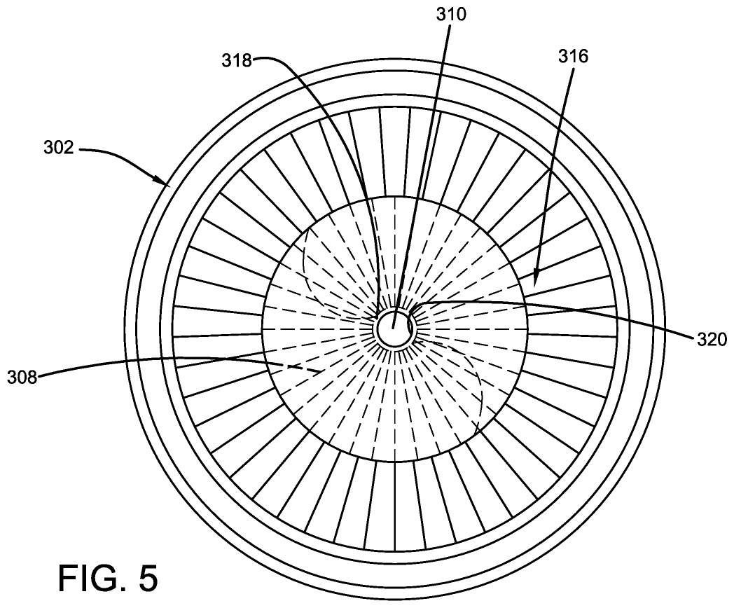

Referring initially to the drawings, FIG. 1 illustrates a perspective view of an airless spray bucket and liner device of the present invention in accordance with the disclosed architecture. The airless spray bucket and liner device 100 of the present invention is designed as a spray paint device for allowing operators to easily spray paint while offering easy and convenient cleaning of the bucket after spraying paint. More specifically, the bucket and liner device 100 includes a bucket 102 that has a frame or perimeter wall 104 and an open rim 106. The frame or perimeter wall 104 can be of any geometrical shape but preferably cylindrical and has a bottom surface or base 108 which includes a clean out exit or hole 110. The clean out exit 110, in one exemplary embodiment, is proximal to a center of the bottom surface or base 108 and is used for conveniently cleaning out paint from the bucket 102 using a vacuum device. The base 108 can be funneled shape and sloping towards the clean out exit 110 (refer to FIG. 5). Alternatively, the clean out exit 110 can be proximal to perimeter wall 104 and the base 108 can be angled to slope towards the clean out exit (refer to FIG. 2).

Referring to FIGS. 1 and 2, for providing a stable base to the bucket 102, an extension 112 is provided along with four supporting legs 114. The extension 112 and the legs 114 extend beyond the base 108 of the bucket 102 and help in placing the bucket 102 on different surface without any tipping or wobbling. The bucket 102 is preferably a five-gallon bucket and serves as the main reservoir for holding paint or stain.

A liner device 116 designed to conform to the interior shape of the bucket 102 is included in the device 100. The liner 116 is placed inside the bucket 102 and serves as a protective barrier between the paint or stain and the bucket 102. More specifically, the liner 116 is inserted into the bucket 102 and then, the paint or stain is stored in the liner 116 and supported by the bucket 102. The liner 116 conforms to inner walls of the bucket 102 and can be placed on the base 108 of the bucket 102.

An airless spray device 118 which can be in the form of a spray gun is connected to the clean out exit 110 of the bucket 102 for creating a high pressure to create a fine spray of paint. The spray device 118 can have a flexible pipe 120 to release the pressurized paint. It will be apparent to a person skilled in the art that the design of the airless spray bucket and liner device 100 provides efficient paint flow from the bucket to the spray gun.

FIG. 2 illustrates a perspective view of the five-gallon bucket of the airless spray bucket and liner device of the present invention in accordance with the disclosed architecture. The bucket 102 can have a logo or indicia 202 on the exterior surface 204 thereof. A pivoting handle 206 is installed for allowing a user to easily maneuver the bucket 102 even when the bucket 102 is filled with paint or stain.

The legs 114 can have a height from about three inches to about five inches and the extension 112 is evenly distributed along the bottom surface or base 108 of the bucket 102. The bucket 102 is sturdy, resistant to chemicals, and capable of withstanding the pressure from the paint or stain being stored therein. Further, the bucket 102 can be made from one of High-Density Polyethylene (HDPE), steel, or any other metal alloy. The bucket 102 can come in different shapes and sizes and can have a storage capacity from about four gallons to about ten gallons to meet requirements of different users.

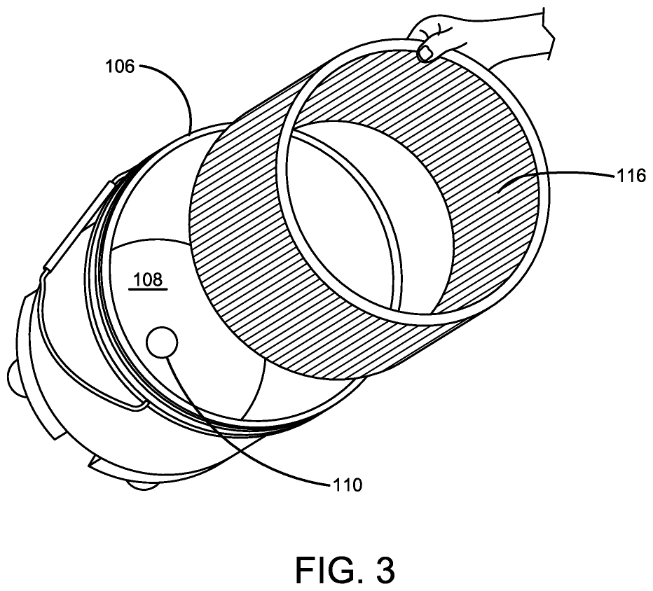

FIG. 3 illustrates a perspective view of showing an exemplary liner positioned inside the bucket 102 for fitting along the interior shape of the bucket in accordance with the disclosed architecture. As illustrated, the liner 116 is a separate and independent device (i.e., selectively insertable and removable) and is designed to be placed inside the bucket 102. The liner 116 can cover the inner wall(s) and the base (i.e., frame) of the bucket 102. In some embodiments, the liner 116 is designed to cover the walls and not the base of the bucket 102 depending on the user requirements.

The liner 116 is flexible and resistant to chemicals. Further, the liner 116 can be made of polyethylene or polypropylene and is disposable. Paint or stain is poured into the bucket 102 after the placement of the liner 116 in the bucket 102. The liner 116 also reduces the amount of paint thinner used for cleaning the bucket 102 and can be removed or collapsed after use for disposal.

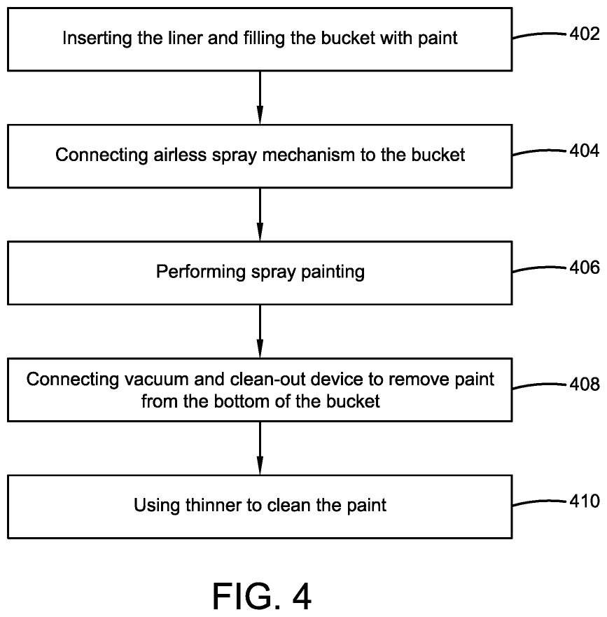

FIG. 4 illustrates a flow chart depicting a process of using the spray bucket and liner device of the present invention for spraying paint and cleaning bucket in accordance with the disclosed architecture. Initially, the liner 116 is placed inside the bucket 102 to conform to the inner surface of the bucket 102 and the bucket 102 is filled with paint or stain (Step 402). Then, an airless spray device is connected to the base 108 of the bucket 102 for atomizing paint into fine spray (Step 404). Any conventional spray gun can be used to connect to the clean out exit or hole 110 as per requirements of the user.

Then in next step 406, spray painting is performed. The spray gun can be moved across the surface in a steady, even motion, maintaining a consistent distance from the surface for uniform coverage of the paint spray. After completion of the spray painting, a vacuum and clean-out device is connected to the hole 110 to remove the paint from base 108 of the bucket 102 (Step 408). It should be noted that the liner 116 can be removed from the bucket 102 before cleaning out paint from the base 108 or can also be removed after use of the cleaning device. The inner walls of the bucket 102 remain clean from the paint as the liner 116 acts as a barrier or liner between the bucket 102 and the paint. Finally, after use of the vacuum and clean-out device and removing the liner 116, the bucket 116 is cleaned using paint thinner (Step 410).

It will be apparent to a person skilled in the art that due to use of the liner 116, the quantity of thinner used for cleaning the bucket 102 is reduced and the manual effort and time is also reduced.

FIG. 5 illustrates a top view of a bucket 302 of the spray bucket and liner system of the present invention in accordance with another embodiment of the disclosed architecture. In the present embodiment, the liner 316 covers the base 308 of the bucket 302. The base 308 can be funneled shape to funnel the paint or stain to a clean out exit or hole 318. All of the paint stored in the bucket 302 can flow through a hole 318 (i.e., funneled hole) in the liner 316 and then through the clean out exit or hole 310 in the bucket base 308 using gravity when desired. It is to be appreciated that the clean out exit 310 can include a cap 320 for removing when the paint stored in the bucket 302 and liner 316 is to be drained, or the cap 320 can remain when the paint in the bucket 302 is to be retained. Further, the thinner can also be used for cleaning out any residual paint from the bucket 302 and hole 310 after draining.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “spray bucket and liner device”, “airless spray bucket and liner device”, “paint spray bucket and line combination system”, and “system” are interchangeable and refer to the airless spray bucket and liner device 100 of the present invention.

Notwithstanding the forgoing, the airless spray bucket and liner device 100 of the present invention can be of any suitable size and configuration as is known in the art without affecting the overall concept of the invention, provided that it accomplishes the above stated objectives. One of ordinary skill in the art will appreciate that the airless spray bucket and liner device 100 as shown in the FIGS. are for illustrative purposes only, and that many other sizes and shapes of the airless spray bucket and liner device 100 are well within the scope of the present disclosure. Although the dimensions of the airless spray bucket and liner device 100 are important design parameters for user convenience, the airless spray bucket and liner device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An airless spray bucket and liner device comprising:
an airless spray device having a bucket including a frame, an open rim, a base, a perimeter wall, and a clean out exit, and further including a liner supported by said base and said perimeter wall;
wherein said liner providing a barrier between said perimeter wall and paint contained within said liner;
wherein said base having said clean out exit proximal to a center of said base;
wherein said base having an extension and a plurality of supporting legs extending therefrom; and
further wherein said liner conforming to an interior shape of said bucket.

2. The bucket and liner device of claim 1, wherein said perimeter wall is cylindrical.

3. The bucket and liner device of claim 2, wherein said bucket having a capacity from 4 gallons to 10 gallons.

4. The bucket and liner device of claim 3, wherein said airless spray device having a spray gun connected to a flexible pipe and attached to said clean out exit for creating a high pressure to create a fine spray of the paint from said spray gun.

5. The bucket and liner device of claim 4, wherein said frame having a pivoting handle for maneuvering said bucket.

6. The bucket and liner device of claim 5, wherein said supporting legs having a height from three inches to five inches.

7. The bucket and liner device of claim 6, wherein said bucket having a material selected from the group consisting of a HDPE, a steel, and an alloy.

8. The bucket and liner device of claim 7, wherein said liner is selectively insertable into said bucket and selectively removable from said bucket.

9. The bucket and liner device of claim 8, wherein said liner is disposable.

10. The bucket and liner device of claim 9, wherein said liner is flexible.

11. A paint bucket and liner device comprising:
a paint bucket including a frame, an open rim, a base, a perimeter wall, and a clean out exit, and further including a liner supported by said base and said perimeter wall;
wherein said liner providing a barrier between said perimeter wall and paint contained within said liner;
wherein said base having said clean out exit proximal to a center of said base;
wherein said base is funneled shape and slopes to said clean out exit; and
further wherein said liner conforming to an interior shape of said bucket.

12. The paint bucket and liner device of claim 11, wherein said perimeter wall is cylindrical.

13. The bucket and liner device of claim 11, wherein said bucket having a capacity from 4 gallons to 10 gallons.

14. The bucket and liner device of claim 11, wherein said base having an extension and a plurality of supporting legs extending therefrom; and
further wherein said supporting legs having a height from three inches to five inches.

15. The bucket and liner device of claim 11, wherein said bucket having a material selected from the group consisting of a HDPE, a steel, and an alloy.

16. The bucket and liner device of claim 11, wherein said liner is selectively insertable into said bucket and selectively removable from said bucket.

17. The bucket and liner device of claim 11, wherein said liner is disposable.

18. The bucket and liner device of claim 11, wherein said liner is flexible.

19. A paint bucket and liner device comprising:
a paint bucket including a frame, an open rim, a base, a perimeter wall, and a clean out exit, and further including a liner supported by said base and said perimeter wall;
wherein said liner providing a barrier between said perimeter wall and paint contained within said liner;
wherein said base having a slope angled towards said clean out exit;
wherein said liner conforming to an interior shape of said bucket;
wherein said liner is flexible; and
further wherein said liner is disposable.

20. The paint bucket and liner device of claim 19, wherein said base is funneled shape and slopes to said clean out exit.
